(19) United States
(12) Patent Application Publication
(10) Pub. No.: US 2001/0006739 A1
(43) Pub. Date: Jul. 5, 2001

(54) Production process of gold color producing material, and gold color producing material produced by the process

(75) Inventors: Toru Hosoda, Tokyo (JP); Akio Yoshida, Tokyo (JP); Hideyuki Koiso, Tokyo (JP)

Correspondence Address: OBLON, SPIVAK, McCLELLAND, MAIER & NEUSTADT, P.C., Fourth Floor, 1755 Jefferson Davis Highway, Arlington, VA, 22202, US

(73) Assignee: Dainichiseika Color & Chemicals Mfg., Co., Ltd.,, Tokyo (JP)

(21) Appl. No.: 09/746,001

(22) Filed: Dec. 26, 2000

(30) Foreign Application Priority Data
Dec. 28, 1999 (JP) 373101/1999

(51) Int. Cl. B32B 15/20; B05D 3/02

(52) U.S. Cl. 428/674; 427/372.2

(57) ABSTRACT

A gold color producing material is produced by coating with a film-forming material a surface of a copper base material, said surface having a metallic gloss, and subjecting the copper base material to heat treatment concurrently with or after the coating.

### BACKGROUND OF THE INVENTION

a) Field of the invention

This invention relates to a novel production process of a gold color producing material, and provides a metallic material, which presents a gold color and has physical properties better than metals such as brass, by using less costly copper metal as a raw material. The resulting metallic material of the gold color is useful for the production of various construction or building materials, household utensils or articles, golden powder, golden ink and the like.

b) Description of the Related Art

Conventional gold color producing materials include interalia alloys of copper with metals, e.g., zinc, such as brass; and gold color producing materials obtained by coloring aluminum with yellow dyes or pigments. These materials are employed in the manufacture of construction or building materials—such as wall materials, roofing materials, interior finish materials and furniture materials (as metal parts in various furniture)—tableware, awarding trophies, and the like.

The above-mentioned brass, however, has a tendency that its surface is readily oxidized in air, a golden color of its surface is discolored and tarnished in a short time, and its commercial value is hence derogated. The colored aluminum products are accompanied with a drawback that they are poor in waterproofness and weatherability and are corroded and readily discolored to lose their golden color. There is hence an outstanding demand for a gold color producing material which is free of such drawbacks. On the other hand, a great deal of golden powder is used in ornaments, golden inks and the like. Gold plating is considered to be ideal for such applications. Gold-plated products are however costly, resulting in an outstanding demand for a gold color producing material replaceable for gold plating.

### SUMMARY OF THE INVENTION

With the foregoing circumstances in view, the present invention has as an object the provision of a gold color producing material, which has a golden gloss similar to gold plating, remains free from discoloration even when brought into contact with acidic or alkaline substances or other chemicals or with air, stably retains the golden gloss, is useful for various applications, and is economical.

The above-described object can be achieved by the invention to be described subsequently herein. Described specifically, the present invention provides a process for the production of a gold color producing material, which comprises coating with a film-forming material a surface of a copper base material, said surface having a metallic gloss; and subjecting the copper base material to heat treatment concurrently with or after said coating. The present invention also provides a gold color producing material obtained by the process.

According to the present invention, the gold color producing material obtained by the process of the present invention presents a glossy, beautiful gold color similar to gold plating. Even after brought into contact with acids or various other chemicals or exposed to heat, the gloss and gold color remain unchanged and are stably retained over a long time. The gold color producing material can, therefore, be employed in the manufacture of construction or building materials—such as wall materials, roofing materials, interior finish materials and furniture materials (as metal parts in various furniture)—tableware, awarding trophies, and the like. As a replacement for gold powder, it can also be used in the production of ornaments and golden inks.

### DETAILED DESCRIPTION OF THE INVENTION AND PREFERRED EMBODIMENTS

The present invention will hereinafter be described in further detail based on preferred embodiments.

The present invention is characterized in that a coating of an organic or inorganic, film-forming material having oxidation resistance, heat resistance and waterproofness is formed on a surface of copper as a base material and the base material is subjected to heat treatment concurrently with or after the formation of the film preferably at 180° C. to 280° C. for several tens seconds to several tens minutes such that the surface of the copper base material presents a gold color.

Examples of the copper base material in the present invention can include pure copper and also, alloys of copper and other metals, such as brass. The form or shape of the copper base material is optional, and no particular limitation is imposed thereon. Illustrative are those formed or machined into powder, sheets, plates, wires, cylinders, and trophies. If the surface of a copper base material has been oxidized or stained before use, it is preferred to have a metallic gloss presented beforehand by treating the surface of the copper base material in a desired manner, such as treatment with a diluted acid or polishing with a fine abrasive, such that an oxidized film or a stain substance on the surface is removed.

A description will next be made about the film-forming material which is employed for the production of the gold color producing material according to the present invention. Any material can be used as the film-forming material in the present invention insofar as it is an inorganic or organic material capable of forming a coating having waterproofness and provided with heat resistance and oxidation resistance sufficient to withstand heat treatment to be described subsequently herein, and therefore, no particular limitation is imposed on the film-forming material. Illustrative are silicate esters, titanate esters, silane compounds other than silicate esters, phosphate esters, high molecular surfactants, heat-resistant, high molecular (polymer) materials.

Examples of the silicate esters can include those containing a hydrolyzable silyl group, such as tetramethoxysilane, tetraethoxysilane, tetrapropoxysilane, tetrabutoxysilane, tetraphenoxysilane, and tetrabenzyloxysilane. Examples of the titanate esters can include tetraisopropyl titanate, tetrabutyl titanate, tetra(2-ethyl)hexyl titanate, and tetrastearyl titanate.

Examples of the silane compounds other than silicate esters can include those containing a hydrolyzable silyl group, such as methyltrimethoxysilane, dimethyldimethoxysilane, n-hexyltrimethoxysilane, n-hexyltriethoxysilane, vinyltrimethoxysilane, vinyltriethoxysilane, 3-aminopropyltrimethoxysilane, 3-aminotriethoxysilane, N-(2-aminoethyl) 3-aminopropyltrimethoxysilane, N-(2-aminoethyl)3-aminopropyltrimethoxysilane, N-(2-aminoethyl)3-aminopropylmethyldimethoxysilane, 3-mercaptopropylmethoxysilane.

The silicate esters and the silane compounds other than the silicate esters form polymerized films by hydrolysis-induced silanol condensation. Further, the titanate esters also form polymerized films by hydrolysis. These compounds can be used either singly or in combination. These compounds are usually employed as solutions dissolved in a desired solvent although they can be used as are.

Examples of the phosphate esters can include trialkyl phosphates, dialkyl phosphates, and monoalkyl phosphates. These phosphate esters also include those capable of forming waterproof, heat resistant, oxidation resistant films by hydrolysis and heat treatment.

Examples of the heat resistant, high-molecular materials can include (meth)acrylate ester polymers, silicon-containing (meth)acrylate ester polymers (common name: acrylsilicone), polyurethane, silicon-containing polyurethane, fluorinated polymers, polyesters, silcon-containing polyesters (common name: silicone polyester), polyesterimides, polyesteramideimides, polyethers, silicon-containing epoxy resins (common name: silicone epoxy), polyamines, and polyimines.

Illustrative of the silicon-containing (meth)acrylate ester (co)polymers are copolymers between methacrylates or acrylates and polymerizable silane compounds or end-vinyl polydimethylsiloxane as disclosed, for example, in JP 4-46306 B and JP 2525302. Illustrative of the silicon-containing polyurethanes are silane compounds containing hydroxyl groups, amino groups or isocyanate groups and reactive groups or hydrolyzable silyl groups as disclosed, for example, in JP 64-51980 A, JP 5-131770 A, and JP 4-216096 A; and polyurethanes with polysiloxane segments contained in molecule chains formed of polyols useful for the production of conventionally-known polyurethanes, polyisocyanates and chain extenders.

Examples of the silicon-containing polyesters can include polyesters obtained by subjecting silane compounds, which contain hydroxyl groups and hydrolyzable silyl groups, and lactones as polymerization initiators to ring-opening polymerization as disclosed, for example, in JP 59-2079922 A; and condensation polymers between the above-described silane compounds with polycarboxylic acids. Illustrative of the other silicon-containing polymers are resins modified with modifiers which contain hydrolyzable silyl group as disclosed, for example, in JP 62-202786.

Illustrative of the high-molecular surfactants are anionic surfactants such as alkyl sulfates, alkyl arylsulfates, alkylaryl sulfonate salts, alkylnaphthalene sulfonate salts, polyoxyethylene alkyl ether sulfonate salts, polyoxyethylene alkyl aryl phosphate salts, naphthalenesulfonic acid-formaldehyde condensation product, polyoxyethylene alkyl phosphate salts, and polyoxyethylene alkylaryl phosphate salts; cationic surfactants such as alkylamine salts and quaternary ammonium salts; nonionic surfactants such as polyoxyethylene alkyl ethers, polyoxyethylene alkyl aryl ethers, polyoxyethylene-polyoxypolypropylene block polymer, sorbitan fatty acid esters, polyoxyethylene alkylamine ethers, fatty acid diethanol amide, acetylene alcohols, and acetylene glycols; and amphoteric surfactants such as alkyl betaine and amine oxides. These compounds also include those capable of forming waterproof, heat resistant and oxidation resistant films by heat treatment.

A description will next be made about the process of the present invention for the production of the gold color producing material. Firstly, a coating of the above-described film-forming material is formed on a surface of a copper base material. If the surface of the copper base material has been oxidized or stained, it is important to remove beforehand the oxidized film or stain substance on the surface. Depending on the application purpose, the above-described film-forming materials can be suitably chosen and used either singly or in combination.

The film-forming material is coated generally as a solution, for example, in a single solvent such as toluene, ethyl acetate, isopropyl alcohol, methyl ethyl ketone or water or a mixed solvent thereof onto the surface of the copper base material by a known method such as spray coating, roll coating or dip coating. The coat amount varies depending on the application of the gold color producing material and cannot be specified in a wholesale manner. Nonetheless, it may be, for example, an amount sufficient to give a dry film thickness of from 0.01 μm to several hundreds μm.

Next, the copper base material coated as described above is subjected to heat treatment. The heat treatment can be effected either concurrently with the coating with the film-forming material (typically, concurrently with the coating of a solution of the film-forming material) or subsequently (after forming a film by removing a solvent by a known method, for example, by drying it in air). The air treatment may be effected in either air or an oxygen-free atmosphere (for example, an inert gas such as nitrogen gas) at 180° C. to 280° C., preferably 200° C. to 260° C. for several tens seconds to several tens minutes. For the heat treatment, a hot air circulation-type oven or the like, which is controlled at the above temperature, is used for example, although no particular limitation is imposed on the heat treatment apparatus.

As the heat treatment is conducted under these conditions, the film-forming material must be one capable of forming a film which has heat resistance and oxidation resistance sufficient to withstand to the heat treatment. A heat treatment temperature outside the above temperature range leads to insufficient or difficult production of a gold color on the surface of the copper base material.

In this manner, the copper base material which has been used in the copper color to date can be provided as a new material colored in a gold color.

The gold color producing material according to the present invention undergoes substantially no discoloration under use conditions of 180° C., and can stably retain its gold color over a long time. Selection of an appropriate film-forming material makes it possible to produce a gold color producing material which is good in physical properties, even in physical properties such as acid resistance, alkali resistance and chemical resistance. Further, the production of this gold color takes place at the interface between the metal and the film so that like conventional gold-plated products, the gold color producing material has an excellent gold gloss far superior to the gold gloss conventionally available by coloring brass or aluminum.

The present invention will hereinafter be described specifically based in Examples.

The followings are treatment solutions which were employed for the formation of films in the following Examples.

### Treatment Solution A

One (1) part by weight of “DAIMETALON COAT CLEAR T” (trade name for an acrylsilicone resin produced by Dainichiseika Color & Chemicals Mfg. Co., Ltd.) as a film-forming material+200 parts by weight of xylene.

### Treatment Solution B

A m-cresol solution (resin content: 0.5 wt. %) of a polyester imide resin as a film-forming material (“BRIDINOL”, trademark; product of Dainichiseika Color & Chemicals Mfg. Co., Ltd.). The polyester imide resin is available from a diimidecarboxylic acid, which is synthesized from trimellitic anhydride and an aromatic diamine and contains 5-membered cyclic imido groups, a polycarboxylic acid and a polyalcohol.

### EXAMPLE 1

### Copper Powder

To 20 parts by weight of laboratory-grade copper powder (200-mesh pass) (product of Junsei Chemical Co., Ltd.) , 1 part by weight of Treatment Solution A was added little by little under stirring such that the copper powder was evenly treated. The thus-treated copper powder was spread to a thickness of about 5 mm in a Petri dish. The Petri dish with the treated copper powder spread thereon was left over for 10 minutes in a hot air circulation-type oven controlled at 240° C. to conduct heat treatment. Copper powder obtained by conducting the heat treatment as described above presented a beautiful gold color.

### EXAMPLE 2

### Copper Sheet

Onto a pure copper sheet (thickness: 0.4 mm) (product of Nihon Test Panel K.K.), Treatment Solution A was coated by a bar coater #12 to give a dry thickness of about 0.01 μm. The coated solution was dried at room temperature in air. The thus-coated copper sheet was left over for 10 minutes in a hot air circulation-type oven controlled at 240° C. to conduct heat treatment. The copper sheet obtained by conducting the heat treatment as described above presented a beautiful gold color.

### EXAMPLE 3

### Copper Wire

A wire (diameter: 0.5 mm) made of pure copper was dipped for 5 seconds in Treatment Solution A, and was then pulled out. The thus-dipped wire was dried for 1 minute in air while being held horizontally at opposite ends thereof. The wire was left over for 10 minutes in a hot air circulation-type oven controlled at 240° C. to conduct heat treatment. The copper wire presented a beautiful gold color.

### EXAMPLE 4

### Copper Coin

A copper coin, the surfaces of which was free from oxidation and had a gloss, was dipped for 5 seconds in Treatment Solution A, and was then pulled out. The thus-dipped coin was dried at room temperature for 1 minute in air while being supported such that localization of the treatment solution was avoided. The coin was then left over for 10 minutes in a hot air circulation-type oven controlled at 240° C. to conduct heat treatment. The copper coin presented a beautiful gold color.

### EXAMPLES 5-8

The procedures of the above Examples were repeated except that Treatment Solution A was changed to Treatment Solution B and the heat treatment temperature was lowered to 220° C., whereby copper powder, copper sheet, copper wire and copper coin, each of which presented a beautiful gold color, were obtained.

### EXAMPLE 9

Copper powder, which presented a gold color, was obtained in a similar manner as in Example 1 except that heat treatment was conducted at 260° C. for 3 minutes in a nitrogen gas stream.

1. A process for the production of a gold color producing material, which comprises:
coating with a film-forming material a surface of a copper base material, said surface having a metallic gloss; and
subjecting said copper base material to heat treatment concurrently with or after said coating.

2. A process according to claim 1, wherein said film-forming material is an inorganic or organic substance which forms a coating having waterproofness and provided with heat resistance and oxidation resistance sufficient to withstand said heat treatment.

3. A process according to claim 1, wherein said heat treatment is effected at 180° C. to 280° C.

4. A process according to claim 1, wherein said heat treatment is effected in air or an oxygen-free atmosphere.

5. A gold color producing material obtained by a process according to any one of claims 1-4.
